(19) United States
(12) Patent Application Publication
(10) Pub. No.: US 2014/0281756 A1
(43) Pub. Date: Sep. 18, 2014

(54) METHOD AND APPARATUS FOR TRACKING DEVICE INTERACTION INFORMATION

(71) Applicant: FORD GLOBAL TECHNOLOGIES, LLC, Dearborn, MI (US)

(72) Inventors: DORON M. ELLIOTT, Detroit, MI (US); JAMES DRAGESCU, San Diego, CA (US)

(73) Assignee: FORD GLOBAL TECHNOLOGIES, LLC, Dearborn, MI (US)

(21) Appl. No.: 13/828,406

(22) Filed: Mar. 14, 2013

(51) Int. Cl. G06F 11/07

(52) U.S. Cl. CPC G06F 11/0787
USPC 714/57

(57) ABSTRACT

A system includes a processor configured to attempt to establish communication with a wireless device. The processor is also configured to store instances of connection failure and related error data. Further, the processor is configured to perform interaction with a connected device. The processor is additionally configured to store interaction failures related error data. The processor is also configured to determine that a remote network connection has been established and report all stored data that has not previously been reported relating to the connection failures and errors and interaction failures and error data to a remote network

### TECHNICAL FIELD

The illustrative embodiments generally relate to a method and apparatus for tracking device interaction information.

### BACKGROUND

As vehicle infotainment systems continue to provide wireless integration with mobile devices, and as mobile device options continue to grow, there is increasing pressure to ensure that as many devices as possible are compatible with as many vehicle systems as possible.

In any given snapshot of time, there are certainly prevalent mobile devices. Whether it is five, fifteen or fifty devices, strategies for device connectivity to a vehicle infotainment system can be implemented. Unfortunately, due largely to the high turn-over in mobile devices, and the non-standardized platforms, hardware and software configurations provided on the devices, it is difficult to continually stay abreast of changing mobile technology.

Further, updates to infotainment systems can often be difficult to implement. Even if a patch or a fix for a particular device is available, a user may have to utilize a memory reflash to implement the change, which can be confusing. Additionally, the user may not even know that the updated patch or version of an infotainment software module is available.

Vehicle infotainment systems are often provided with connective capability for wireless devices, such as cell phones, smart phones, tablets, etc. While very convenient, this also poses some potential problems. Since cellular phone companies have released literally hundreds, if not thousands, of variations of phones, it can be difficult to ensure compatibility with the wide variety of phones in the market.

Further, vehicle OEMs often desire to penetrate new and emerging markets. This can present a whole new crop of phones with which to deal, since phones in India, for example, may be far different from phones in the United States.

### SUMMARY

In a first illustrative embodiment, a system includes a processor configured to attempt to establish communication with a wireless device. The processor is also configured to store instances of connection failure and related error data. Further, the processor is configured to perform interaction with a connected device. The processor is additionally configured to store interaction failures related error data. The processor is also configured to determine that a remote network connection has been established and report all stored data that has not previously been reported relating to the connection failures and errors and interaction failures and error data to a remote network.

In a second illustrative embodiment, a computer-implemented method includes attempting to establish communication with a wireless device. The method also includes storing instances of connection failure and related error data. Further, the method includes performing interaction from a VCS to a connected device. The method additionally includes storing interaction failures related error data. The method also includes determining that a remote network connection has been established and reporting all stored data that has not previously been reported relating to the connection failures and errors and interaction failures and error data to a remote network.

In a third illustrative embodiment, a non-transitory computer readable storage medium stores instructions that, when executed by a processor, cause the processor to perform a method including attempting to establish communication with a wireless device. The method also includes storing instances of connection failure and related error data. Further, the method includes performing interaction from a VCS to a connected device. The method additionally includes storing interaction failures related error data. The method also includes determining that a remote network connection has been established and reporting all stored data that has not previously been reported relating to the connection failures and errors and interaction failures and error data to a remote network.

### BRIEF DESCRIPTION OF THE DRAWINGS

FIG. 1 shows an illustrative vehicle computing system;

FIG. 2 shows an illustrative process for phone interaction tracking; and

FIG. 3 shows a second illustrative process for phone interaction tracking.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

FIG. 1 illustrates an example block topology for a vehicle based computing system 1 (VCS) for a vehicle 31. An example of such a vehicle-based computing system 1 is the SYNC system manufactured by THE FORD MOTOR COMPANY. A vehicle enabled with a vehicle-based computing system may contain a visual front end interface 4 located in the vehicle. The user may also be able to interact with the interface if it is provided, for example, with a touch sensitive screen. In another illustrative embodiment, the interaction occurs through, button presses, audible speech and speech synthesis.

In the illustrative embodiment 1 shown in FIG. 1, a processor 3 controls at least some portion of the operation of the vehicle-based computing system. Provided within the vehicle, the processor allows onboard processing of commands and routines. Further, the processor is connected to both non-persistent 5 and persistent storage 7. In this illustrative embodiment, the non-persistent storage is random access memory (RAM) and the persistent storage is a hard disk drive (HDD) or flash memory.

The processor is also provided with a number of different inputs allowing the user to interface with the processor. In this illustrative embodiment, a microphone 29, an auxiliary input 25 (for input 33), a USB input 23, a GPS input 24 and a BLUETOOTH input 15 are all provided. An input selector 51 is also provided, to allow a user to swap between various inputs. Input to both the microphone and the auxiliary connector is converted from analog to digital by a converter 27 before being passed to the processor. Although not shown, numerous of the vehicle components and auxiliary components in communication with the VCS may use a vehicle network (such as, but not limited to, a CAN bus) to pass data to and from the VCS (or components thereof).

Outputs to the system can include, but are not limited to, a visual display 4 and a speaker 13 or stereo system output. The speaker is connected to an amplifier 11 and receives its signal from the processor 3 through a digital-to-analog converter 9. Output can also be made to a remote BLUETOOTH device such as PND 54 or a USB device such as vehicle navigation device 60 along the bi-directional data streams shown at 19 and 21 respectively.

In one illustrative embodiment, the system 1 uses the BLUETOOTH transceiver 15 to communicate 17 with a user's nomadic device 53 (e.g., cell phone, smart phone, PDA, or any other device having wireless remote network connectivity). The nomadic device can then be used to communicate 59 with a network 61 outside the vehicle 31 through, for example, communication 55 with a cellular tower 57. In some embodiments, tower 57 may be a WiFi access point.

Exemplary communication between the nomadic device and the BLUETOOTH transceiver is represented by signal 14.

Pairing a nomadic device 53 and the BLUETOOTH transceiver 15 can be instructed through a button 52 or similar input. Accordingly, the CPU is instructed that the onboard BLUETOOTH transceiver will be paired with a BLUETOOTH transceiver in a nomadic device.

Data may be communicated between CPU 3 and network 61 utilizing, for example, a data-plan, data over voice, or DTMF tones associated with nomadic device 53. Alternatively, it may be desirable to include an onboard modem 63 having antenna 18 in order to communicate 16 data between CPU 3 and network 61 over the voice band. The nomadic device 53 can then be used to communicate 59 with a network 61 outside the vehicle 31 through, for example, communication 55 with a cellular tower 57. In some embodiments, the modem 63 may establish communication 20 with the tower 57 for communicating with network 61. As a non-limiting example, modem 63 may be a USB cellular modem and communication 20 may be cellular communication.

In one illustrative embodiment, the processor is provided with an operating system including an API to communicate with modem application software. The modem application software may access an embedded module or firmware on the BLUETOOTH transceiver to complete wireless communication with a remote BLUETOOTH transceiver (such as that found in a nomadic device). Bluetooth is a subset of the IEEE 802 PAN (personal area network) protocols. IEEE 802 LAN (local area network) protocols include WiFi and have considerable cross-functionality with IEEE 802 PAN. Both are suitable for wireless communication within a vehicle. Another communication means that can be used in this realm is free-space optical communication (such as IrDA) and non-standardized consumer IR protocols.

In another embodiment, nomadic device 53 includes a modem for voice band or broadband data communication. In the data-over-voice embodiment, a technique known as frequency division multiplexing may be implemented when the owner of the nomadic device can talk over the device while data is being transferred. At other times, when the owner is not using the device, the data transfer can use the whole bandwidth (300 Hz to 3.4 kHz in one example). While frequency division multiplexing may be common for analog cellular communication between the vehicle and the internet, and is still used, it has been largely replaced by hybrids of with Code Domian Multiple Access (CDMA), Time Domain Multiple Access (TDMA), Space-Domian Multiple Access (SDMA) for digital cellular communication. These are all ITU IMT-2000 (3G) compliant standards and offer data rates up to 2 mbs for stationary or walking users and 385 kbs for users in a moving vehicle. 3G standards are now being replaced by IMT-Advanced (4G) which offers 100 mbs for users in a vehicle and 1 gbs for stationary users. If the user has a data-plan associated with the nomadic device, it is possible that the data-plan allows for broad-band transmission and the system could use a much wider bandwidth (speeding up data transfer). In still another embodiment, nomadic device 53 is replaced with a cellular communication device (not shown) that is installed to vehicle 31. In yet another embodiment, the ND 53 may be a wireless local area network (LAN) device capable of communication over, for example (and without limitation), an 802.11g network (i.e., WiFi) or a WiMax network.

In one embodiment, incoming data can be passed through the nomadic device via a data-over-voice or data-plan, through the onboard BLUETOOTH transceiver and into the vehicle's internal processor 3. In the case of certain temporary data, for example, the data can be stored on the HDD or other storage media 7 until such time as the data is no longer needed.

Additional sources that may interface with the vehicle include a personal navigation device 54, having, for example, a USB connection 56 and/or an antenna 58, a vehicle navigation device 60 having a USB 62 or other connection, an onboard GPS device 24, or remote navigation system (not shown) having connectivity to network 61. USB is one of a class of serial networking protocols. IEEE 1394 (firewire), EIA (Electronics Industry Association) serial protocols, IEEE 1284 (Centronics Port), S/PDIF (Sony/Philips Digital Interconnect Format) and USB-IF (USB Implementers Forum) form the backbone of the device-device serial standards. Most of the protocols can be implemented for either electrical or optical communication.

Further, the CPU could be in communication with a variety of other auxiliary devices 65. These devices can be connected through a wireless 67 or wired 69 connection. Auxiliary device 65 may include, but are not limited to, personal media players, wireless health devices, portable computers, and the like.

Also, or alternatively, the CPU could be connected to a vehicle based wireless router 73, using for example a WiFi 71 transceiver. This could allow the CPU to connect to remote networks in range of the local router 73.

In addition to having exemplary processes executed by a vehicle computing system located in a vehicle, in certain embodiments, the exemplary processes may be executed by a computing system in communication with a vehicle computing system. Such a system may include, but is not limited to, a wireless device (e.g., and without limitation, a mobile phone) or a remote computing system (e.g., and without limitation, a server) connected through the wireless device. Collectively, such systems may be referred to as vehicle associated computing systems (VACS). In certain embodiments particular components of the VACS may perform particular portions of a process depending on the particular implementation of the system. By way of example and not limitation, if a process has a step of sending or receiving information with a paired wireless device, then it is likely that the wireless device is not performing the process, since the wireless device would not “send and receive” information with itself. One of ordinary skill in the art will understand when it is inappropriate to apply a particular VACS to a given solution. In all solutions, it is contemplated that at least the vehicle computing system (VCS) located within the vehicle itself is capable of performing the exemplary processes.

With the vast number of cell phones and mobile devices on the market, customers using a particular phone to interact with a vehicle computing system may often be unaware of the compatibility of their device with a vehicle computing system. Similarly, while an OEM can confirm that a particular device initially works with a vehicle computing system, the OEM may have difficulty gauging the compatibility of the device over time, since all functions of all devices would be difficult to test.

Accordingly, the illustrative embodiments describe systems and methods for tracking device compatibility information over time. Users can be alerted to compatibility issues and fixes, based on observed data. OEM engineers can examine the aggregated data, which can allow them to more quickly observe problems related to a particular device. The aggregated information can also allow the engineers to observe if a given device is working as intended, based on initial configurations or applied hot-fixes.

FIG. 2 shows an illustrative process for phone interaction tracking. In this illustrative embodiment, the process creates a device profile for future error reporting. All aggregated information relating to device connectivity issues and device interaction failures can be stored locally until such time as reporting is permitted.

In this illustrative example, the process attempts to connect to the wireless device 201. Until a connection is established 203, or until a maximum number of connection attempts is reached 205, the system will continue to attempt connection to the device 207.

If a connection is not possible because of an unknown condition, the process may exit, since there may not be any information to be gained from the device. On the other hand, the error 209, if known, may be recorded for reporting to a vehicle OEM. In addition to gathering the error information, the process may attempt to gather any available device information 211. This gathering can be done automatically, or it can involve gathering information directly from a user through a series of questions about the device.

The error data and the device information, if any, can be stored for reporting 213. The reporting information may also include such information as vehicle software versions at the time of the error, vehicle features and equipment builds, a VIN number and any other information that may be useful in diagnosing the problem.

Until a successful connection is established with the remote network through a wireless device, the process may wait 215. Once the connection is established, reporting of the error information and/or vehicle information may be performed 217.

If a connection is successfully established with the device, the process may check to see if there is a profile associated with the device 219. The profile may be useful for aggregating device information over time, as interactions persist. The profile can also store relevant device information, such as, but not limited to, make and model, software versions, service provider and other information. Then, whenever data is gathered for reporting, the system will also have all the relevant information about the device already gathered and stored. If a profile doesn't exist, one can be created for the device 221.

Periodically, devices receive updates from the service providers or manufacturers. In such a case, it may be useful to store the newly generated device information. Further, certain applications accessed by the VCS on the device may be stored with respect to the profile. If these applications are updated, it may also be useful to store the new software versions associated with the updates. If there is new device information present 223, the process may store the new information associated with the device profile.

Once the profile is accessed, created and/or updated, the process may continue on to access and interact with the device 227. If the interaction is successful within allowed parameters 229, the process may store the successful interaction information with respect to the device profile 235. On the other hand, if there is an error or other issue with the interaction, the process may store data relating to the failure with respect to the device profile 231.

Additionally, if there is error information associated with the device 233, the process may determine and store the error information with respect to the device profile 237. This error information can be used for later reporting at a point in the future. Once a phone is connected to the remote network, and error reporting is permitted 239, the process can report the information, including device information, system information, failure information and error information 241. With each success or failure, the system may take a snapshot of both the device information and the system information (software/hardware configuration and/or versions, applications existing on the device, etc.).

FIG. 3 shows a second illustrative process for phone interaction tracking. In this illustrative embodiment, a vehicle computing system will be used for tracking device interaction and reporting purposes. The VCS first attempts to connect to a given device that a user has brought into the vehicle 301. Since the VCS may be unable to connect to all devices, there may be an instance where the VCS is unable to connect to a device 303.

If the VCS is initially unable to connect to the device, the process may continue to attempt to connect to the device 307 for a number of retries 305. It is unlikely that the process will attempt connection indefinitely, as the user could remain unaware that a connection was not established and this could lead to frustration.

Once the maximum number of retries has been reached, the process attempts to gather any available device information 309. Since a connection was unsuccessful, there may not be any information that can be obtained on the device. On the other hand, certain device information may still be obtainable from a BLUETOOTH profile, a WiFi profile, or other information sources. In one example, the system may even ask the driver to enter some basic information about the device, so the automotive OEM can consider steps to take with respect to that device to allow communication at some later date with an update to the system.

If there is any information available about the device 311, the process may store the information so that the device can be identified to the OEM as an unconnectable device. In this illustrative embodiment, the user is also alerted as to the inability to connect to the device 315, so that the user can attempt to connect a different device, or take other OEM suggested measures that may facilitate connectivity.

Since the current device was unable to connect, the VCS will be unlikely to have a present connection to a wireless network over which it can perform reporting. Another device may be connected at some point, however, so that the VCS has a connection medium through which to contact a remote network. Once a connection has been established 317, the process may upload the information relating to the device's inability to connect (along with any device identifying information and other relevant information, such as, but not limited to, current versions of software modules installed on the VCS, etc.).

In response to the uploaded information, the system may receive incoming advice to provide to the user 321. For example, if an outdated connectivity module is present on the vehicle, the advice may be to update the module to a known version that is compatible with the device. Other suggestions may also be present, and the suggestions can even include an acknowledgement that the connectivity issues are known, along with a projected timetable for a fix, if known. The received advice can then be presented to the user within the vehicle 323.

If the device is able to connect with the VCS, the VCS will then begin to interact with the device in a normal fashion 325. Interaction can include, but is not limited to, running applications, utilizing GPS, navigation services, data transfer, remote control of the device and applications running thereon, etc. Each interaction between the VCS and the device will result in success, partial success, failure and/or some errors. If the interaction is completely successful 327, the process will continue to interact with the device.

If there is any failure associated with the interaction, the process will report the failure 329. If there is an established connection and reporting is permitted, the process will report the failure on the spot, along with any additional information that can be useful. The information can include, but is not limited to, phone make and model, phone software, current VCS software, current VCS hardware, etc. If reporting is not permitted, the process will store the data until such time as reporting is permissible.

There may also be one or more errors 331 associated with the complete or partial failure. Sometimes, an error will not be known, so there may not be an error message generated, merely an expected success that does not occur. In other instances, a specific error message may be generated that is useful in determining what the problem in communication was. In such an instance, the errors can be reported to the remote server 333. As with the failure reporting, additional information may be reported relating to the phone and the vehicle. Also, if reporting is not permitted, as with the failure reporting, the system may store the error information until such time as error reporting is permitted.

Once a failure and/or an error is reported to the remote system, the process may receive advice relating to the failure or error 335. Again, this may be advice about a possible update that may correct the problem, recommended fixes to the problem, an estimated date of problem correction, etc. The advice, if received, can be presented to the user to help rectify the problem or inform the user of the OEM's knowledge of the problem. Interaction then continues.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A system comprising:
a processor configured to:
attempt to establish communication with a wireless device;
store instances of connection failure and related error data;
perform interaction with a connected device;
store interaction failures related error data;
determine that a remote network connection has been established; and
report all stored data that has not previously been reported relating to the connection failures and errors and interaction failures and error data to a remote network.

2. The system of claim 1, wherein the processor is further configured to create a device profile for a wireless device, including wireless device configuration data, and to store failures and errors related to the wireless device with respect to the profile.

3. The system of claim 2, wherein the wireless device configuration data includes device software and hardware information.

4. The system of claim 3, wherein the processor is further configured to store information about a vehicle configuration with respect to a stored failure or error relating to connection or interaction.

5. The system of claim 4, wherein the information about a vehicle configuration includes current vehicle software versions.

6. The system of claim 5, wherein the information about a vehicle configuration includes a current vehicle hardware build.

7. The system of claim 6, wherein the processor is further configured to report stored wireless device configuration data and vehicle configuration data with respect to one or more failures or errors that is reported.

8. A computer-implemented method comprising:
attempting to establish communication with a wireless device;
storing instances of connection failure and related error data;
performing interaction from a VCS to a connected device;
storing interaction failures related error data;
determining that a remote network connection has been established; and
reporting all stored data that has not previously been reported relating to the connection failures and errors and interaction failures and error data to a remote network.

9. The method of claim 8, further comprising creating a device profile for a wireless device, including wireless device configuration data, and storing failures and errors related to the wireless device with respect to the profile.

10. The method of claim 9, wherein the wireless device configuration data includes device software and hardware information.

11. The method of claim 10, further comprising storing information about a vehicle configuration with respect to a stored failure or error relating to connection or interaction.

12. The method of claim 11, wherein the information about a vehicle configuration includes current vehicle software versions.

13. The method of claim 12, wherein the information about a vehicle configuration includes a current vehicle hardware build.

14. The method of claim 13, further comprising reporting stored wireless device configuration data and vehicle configuration data with respect to one or more failures or errors that is reported.

15. A non-transitory computer readable storage medium, storing instructions that, when executed by a processor, cause the processor to perform a method comprising:
attempting to establish communication with a wireless device;
storing instances of connection failure and related error data;
performing interaction from a VCS to a connected device;
storing interaction failures related error data;
determining that a remote network connection has been established; and
reporting all stored data that has not previously been reported relating to the connection failures and errors and interaction failures and error data to a remote network.

16. The storage medium of claim 15, further comprising creating a device profile for a wireless device, including wireless device configuration data, and storing failures and errors related to the wireless device with respect to the profile.

17. The storage medium of claim 16, wherein the wireless device configuration data includes device software and hardware information.

18. The storage medium of claim 17, further comprising storing information about a vehicle configuration with respect to a stored failure or error relating to connection or interaction.

19. The storage medium of claim 18, wherein the information about a vehicle configuration includes current vehicle software versions.

20. The storage medium of claim 19, further comprising reporting stored wireless device configuration data and vehicle configuration data with respect to one or more failures or errors that is reported.
